(19) United States
(12) Patent Application Publication
(10) Pub. No.: US 2020/0332547 A1
(43) Pub. Date: Oct. 22, 2020

(54) ARCHITECTED MATERIAL DESIGN FOR SEISMIC ISOLATION

(71) Applicant: THE REGENTS OF THE UNIVERSITY OF CALIFORNIA, Oakland, CA (US)

(72) Inventors: Noemi Bonessio, Irvine, CA (US); Lorenzo Valdevit, Irvine, CA (US); Giuseppe Lomiento, Pomona, CA (US)

(21) Appl. No.: 16/917,613

(22) Filed: Jun. 30, 2020

Related U.S. Application Data
(63) Continuation of application No. 15/580,613, filed on Dec. 7, 2017.
(60) Provisional application No. 62/173,637, filed on Jun. 10, 2015.

(51) Int. Cl. E04H 9/02; F16F 15/073; E01D 19/04; F16F 15/04; E04B 1/98

(52) U.S. Cl. CPC E04H 9/022; F16F 15/073; E04B 1/98; F16F 15/046; E01D 19/041; E01D 19/04

(57) ABSTRACT

Seismic protection materials are derived from assemblages of unit cells, where each of the cells has a core, one or more shells disposed about the core, and rigid plates bounding the shells. The cores limit relative vertical movement between the plates, and the shell(s) limit relative lateral motion between the plates. Uncompressed cores are preferably substantially spherical or cylindrical, and can be solid or hollow. Unit cells can be aligned in same or different directions, both within a given layer of cells, and in different layers of cells. Assemblages can have any suitable overall shape and size, depending upon application, and for example can support objects ranging from table top equipment to large buildings and bridges.

### CROSS-REFERENCES TO RELATED APPLICATIONS

This application is a continuation and claims benefit of U.S. patent application Ser. No. 15/580,613 filed Dec. 7, 2017, which is a 371 application of PCT/US2016/036707 filed Jun. 9, 2016, which claims the benefit of U.S. Provisional Patent Application No. 62/173,637 filed Jun. 10, 2015, the specification(s) of which is/are incorporated by reference herein in its entirety.

### FIELD OF THE INVENTION

The field of the invention is seismic isolation devices for buildings, bridges and other structures.

### BACKGROUND

The background description includes information that may be useful in understanding the present invention. It is not an admission that any of the information provided herein is prior art or relevant to the presently claimed invention, or that any publication specifically or implicitly referenced is prior art.

Seismic isolators may be used on structures for safety and economic reasons. Seismic isolation overcomes the limitations of traditional seismic design, which is based on designing and detailing a structure to provide sufficient ductility and energy—absorption capacity. While traditional seismic design allows for extensive damage within the structure during seismic events and loss of functionality for extended periods of time with possibly large economic losses, seismic isolation is aimed at preventing structural damages and maintaining structures operational.

Seismic isolation increases the resiliency of structures by absorbing and dissipating, at the isolation interface, part of the vibration energy generated by ground shaking events, and preventing this energy from affecting the structure. An isolation interface consists of a separation between the isolated super-structure and the non-isolated substructure, generally the foundation of the structure. The only connection between super-structure and substructure is through seismic isolators. Isolators sustain the super-structure and have high lateral flexibility.

Due to this flexibility, the super-structure is partially decoupled by the lateral ground motion and, during shaking events, tends to stay for inertia in its original position, experiencing only limited vibration with low seismic acceleration. A further reduction of the seismic acceleration is also provided by the energy dissipation capacity of the seismic isolators.

To obtain this kind of isolation, seismic isolators are required to have high vertical stiffness and strength, in order to sustain the weight of the structure, and a very low horizontal stiffness with high horizontal deformation capacity to allow large relative lateral displacement between super-structure and sub-structure while sustaining vertical loads. A large number of the prior art patents for seismic isolators or supports have never been implemented in actual structures because of the high costs associated with their implementation, (see e.g., US Patent Application No. 2006/0174555), or because they are too complex, or not reliable enough and require excessive maintenance. The most popular isolation bearings currently used for passive vibration control of civil structures are steel reinforced elastomeric bearings (SREB) (shown in FIG. 1A) and sliding pendulum bearings (shown in FIG. 1B).

A typical steel reinforced elastomeric bearing is made of thin layers of rubber and steel. Inner steel shims are provided to increase the vertical stiffness while the rubber pads accommodate lateral displacements through shearing strains in the rubber layers. In order to increase the dissipation capacity, a central lead plug can be incorporated to form a lead rubber bearing, as described in U.S. Pat. Nos. 4,117,637, 4,499,694, and 4,593,502, while other approaches involve the use of dampers or mild steel elements. In high damping rubber bearings (e.g., U.S. Pat. No. 6,107,389), the elastomer can also be compounded to increase its damping capabilities. Rubber compounds with high levels of damping, however, may be severely affected by creep phenomena under large vertical loads.

As is known in the art, (see e.g., U.S. Pat. No. 8,789,320) a drawback of a typical steel reinforced elastomeric bearing is its susceptibility to instability phenomena, which limits the maximum allowed lateral displacement and constraints the dimensions of the isolator. The lateral stiffness of rubber isolators decreases as vertical loads and lateral displacements increase, until the isolator becomes instable. Since elastomeric isolators become instable at large displacements, the maximum shear deformations in the rubber need to be limited to prevent buckling from occurring. Increase of the height of the rubber may be considered to enhance the lateral displacement capability, but reduces stability and vertical stiffness of the isolator. An increase of the in-plan dimensions of the isolator reduces the risk of instability, but also requires augmented height of the rubber to prevent excessive lateral stiffness.

For lead rubber bearings, another constraint on the dimensions is set by the need of high pressure to maintain the lead core confinement. Increase of the plan dimensions need to be limited in order to prevent excessive reduction of the confining axial compressive stress. Finally, as is known in the art, a drawback of these bearings is associated with wearing of the material. As described in U.S. Pat. No. 6,107,389, the rubber creeps over time, resulting in poor long-term endurance.

Sliding pendulum bearings (as shown in FIG. 1B) employ sliders and concave surfaces along which the sliders move. For example, a typical friction pendulum device includes a lower support and an upper support, both with a concave sliding surface, which are linked to the super-structure and the foundation, respectively. The two concave surfaces are separated by a slider with two convex surfaces that match the radius of curvature of the upper and lower supports. The slider is coated with a sliding material (e.g., PTFE, etc) to reduce friction forces at the contact with the sliding surfaces. Lateral forces that exceed the frictional resistance on the contact surfaces generate oscillation of the super-structure, accordingly to the motion of a pendulum. Use of large radius of curvature for the sliding surfaces determines high period of oscillation of the super-structure, with consequent reduction of the accelerations induced by seismic events. The seismic response is additionally reduced by the energy dissipation provided by the friction forces during the sliding motion.

As is known in the art, the friction properties of the contact materials have important effects on the performance of these sliding bearings. For example, the importance of friction properties of the contact materials is described in following articles: Quaglini V., Dubini P., Ferroni D., Poggi C. (2009) “Influence of counterface roughness on friction properties of engineering plastics for bearing applications” Materials and Design, 30, 1650-1658. DOI: 10.1016/j.matdes.2008.07.025; Hutchings IM. “Tribology, friction and wear of engineering material. London” Edward Arnold; 1992; Lomiento G., Bonessio N., Benzoni G. (2013) “Friction model for sliding bearings under seismic excitation” Journal of Earthquake Engineering, 17(8), 1162-1191. DOI: 10.1080/13632469.2013.814611; Lomiento, G., Bonessio, N., Benzoni, G. “Effects of motion and loading characteristics on sliding concave bearing performance”, Proceedings of the 15th World Conference on Earthquake Engineering, Lisbon, Portugal, 24-28 Sep. 2012; Benzoni, G., Lomiento, G., Bonessio, N. (2013). “Experimental Results from multi-directional Tests on Friction-based Isolators”, Proceedings of the 13th World Conference on Seismic Isolation, Energy Dissipation and Active Vibration Control of Structures, Sendai, Japan, 24-27, Sep. 2013.

High levels of the coefficient of friction reduce the lateral displacements of the super-structure, and prevent excessive displacement of the structure under wind loads. Low friction coefficients, instead, improve the sliding isolator capacity to restore its initial position after an earthquake, and reduce maximum accelerations experienced by the super-structure during earthquakes. The friction during the sliding movement of the intermediate elements with respect to each other causes also problems to the isolators, as described in U.S. Pat. No. 8,011,142. Spurious moments against the rotation are generated by the friction forces on the contact surfaces. Also, friction forces cause wear problems of the sliding materials, which results in a reduced service life of the isolator if complex lubrication systems are not provided.

In conventional sliding pendulum bearings, a low friction material with elasto-plastic properties, such as PTFE or UHMWPE, is used (e.g., U.S. Pat. No. 8,371,075). As is known in the art (e.g., US Pat. Application No. 2014/0026498A1), these conventional sliding materials do not have adequate wear resistance and are subjected to continuous wearing during in service movements of a structure. A further drawback of sliding material such as PTFE or UHMWPE is the dependency of their friction characteristics on sliding velocity, contact pressure (as disclosed in Quaglini at al. 2009, Hutchings, 1992) and heat generated during cyclic sliding (as disclosed in Lomiento et al. 2013, Benzoni et al. 2013). This dependency causes variations of the friction properties during shaking events that may alter the seismic performance of the isolator. This means that the isolator may no longer function as intended in its application.

Other sliding materials, such as unfilled hard PTFE or UHMWPE (e.g., U.S. Pat. No. 8,011,142, European Pat. No. EP1836404), have shown a high wear resistance but only allow for limited dissipation of energy during seismic events. In some sliding pendulum bearings (e.g., U.S. Pat. No. 5,867,951), the low friction material employed is a thermoplastic synthetic resin. A drawback of these materials is their sensitivity to even minor inaccuracies and defects in the bearing components, which can lead to significant reduction of the bearing capacity, as described in U.S. Pat. No. 8,371,075. One common drawback to all state-of-art isolators is the cost of the prototype and production testing to assess their seismic performance. As the performance of these isolators depends on the scale of the whole assembly, large scale testing is required to assess their performance. Any change of geometry and size of the isolators requires additional tests, which affect the final cost of the delivered product, well beyond the actual material and labor production cost. Full scale seismic isolators testing are generally performed in very expensive dedicated facilities (as disclosed in Benzoni, G., Lomiento, G., Bonessio, N. (2011) “Testing Protocols for Seismic Isolation Systems”, Proceedings of the 14^{th} Italian Conference on Earthquake Engineering, Bari, Italy, 18-22 Sep. 2011).

Even if the base seismic isolation approach has already gained recognition as an effective protection against earthquakes, its extensive application is limited by the drawbacks of existing isolators. The main drawbacks associated with the material limitations, such as the creep and the wear of the rubber for steel rubber bearings or the lack of reliability of the friction performance of sliding materials for sliding isolators, can be overcome by using innovative architected materials (as disclosed in T. A. Schaedler, A. J. Jacobsen, A. Torrents, A. E. Sorensen, J. Lian, J. R. Greer, L. Valdevit, W. B. Carter, ‘Ultralight Metallic Microlattices’, Science, 334 (6058) pp. 962-96 (2011);), as proposed in this invention.

Other US Patents and patent applications describe technologies related to seismic isolation. The relevant US Patents include U.S. Pat. No. 3,794,277 to Smedley et al., U.S. Pat. No. 4,187,573 to Fyfe et al., U.S. Pat. No. 4,320,549 to Greb, U.S. Pat. No. 5,461,835 to Tarics, US Patent Application No. 2013/0167707 to Tsai, U.S. Pat. No. 4,599,834 to Fujimoto et al., U.S. Pat. No. 4,644,714 to Zayas, U.S. Pat. No. 5,491,937 to Watson et al., U.S. Pat. No. 6,021,992 to Yen et al., U.S. Pat. No. 6,126,136 to Yen et al., U.S. Pat. No. 6,160,864 to Gou et al., U.S. Pat. No. 7,814,714 to Tsai, US Patent application No. 2008/0098671 to Tsai, and US Patent application No. 2011/0016805 to Tsai.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need in the art for seismic isolation materials that can absorb and dissipate shaking events within the material, while restricting the sort of excessive displacements common to bearing-type isolators, and shear deformations common to rubber-type isolators.

### SUMMARY OF THE INVENTION

The present invention provides apparatus, systems, and methods in which a novel class of materials can be used for the seismic protection of structures, bridges, and machines.

One aspect of the inventive subject matter includes an apparatus for seismic isolation. The apparatus includes a unit cell and a three-dimensional organized cellular material. In a preferred embodiment, the unit cell includes at least two plates disposed separately by a non-zero distance and at least one shell attached to the two plates.

Another aspect of the inventive subject matter includes an apparatus for seismic isolation. The apparatus includes a three-dimensional organized cellular material having a plurality of unit cells with a shear strain deformation capacity between 0.2 and 2, a Shear modulus to Young's modulus ratio G<10 GPA and E=10 to 60 GPA between 0.01 and 0.1, and a damping ratio between 0.05 and 0.40.

Another aspect of the inventive subject matter includes an apparatus for seismic isolation. The apparatus includes a three-dimensional organized cellular material, which has a void to full volume ratio between 0.02 and 0.5, inclusive.

Still another aspect of the inventive subject matter includes a method of providing protection for a structure, comprising supporting the structure at least in part with a seismic isolation device. The device includes a unit cell and a three-dimensional organized cellular material. In a preferred embodiment, the unit cell includes at least two plates disposed separately by a non-zero distance and at least one shell attached to the two plates.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1A is a cut-away view of a prior art example of steel reinforce elastomeric bearing.

FIG. 1B is an exploded view of a prior art example of a sliding pendulum bearing.

FIG. 2 is a graph showing horizontal shear stiffness versus vertical compressive stiffness for traditional existing materials, and a target area for inventive periodic cellular-materials.

FIG. 3 is a perspective of a preferred unit-cell in tridimensional (3D) view.

FIGS. 4A-4F are vertical cross-sections of different configurations of internal cores of different unit cell embodiments.

FIG. 4G is a perspective view of a unit cell having multiple concentric shells with different curvatures and different orientation of the shells.

FIG. 5 is a schematic diagram showing two layers of unit cells oriented in orthogonal directions.

FIG. 6 is a perspective view of a seismic protection structure having two layers of the same material oriented in the x and y directions of a unit cell.

FIG. 7 is a perspective view of a seismic protection structure having four layers of the same material oriented in the x and y directions of a unit cell.

FIG. 8 is a cutaway of a macroscopic object having four layers oriented in different directions with a compact shape suitable for seismic protection of a variety of structures.

FIG. 9 is a perspective view of a macroscopic object having (n) layers with a compact shape.

FIG. 10 is a side view of a double cone shape of the macroscopic object having (n) layers made with the seismic material suitable for a bridge.

FIG. 11 is a graph of Young's Modulus and Shear Modulus of architected materials according to example embodiments of the present invention obtained with different values of shells thickness (S1=0.1 mm, S2=0.2 mm, S3=0.4 mm), different values of rigid plate's length (L1=5 mm, L2=10 mm, L3=20 mm), and different core (hollow and solid).

FIG. 12A is a graph of the Shear Modulus of architected materials according to example embodiments of the present invention, obtained with different values of rigid plate's length.

FIG. 12B is a graph of the Shear Modulus of architected materials according to example embodiments of the present invention, obtained with different values of shells thickness.

FIG. 13A is a graph of an option for a shape of a force-displacement loop that can be obtained by changing the shells thickness of the unit cell with rigid plate's length equal to L₁=5 mm.

FIG. 13B is a graph of an option for a shape of a force-displacement loop that can be obtained by changing the shells thickness of the unit cell with rigid plate's length equal to L₂=10 mm.

FIG. 13C is a graphed example of an option for a shape of a force-displacement loop that can be obtained by changing the shells thickness of the unit cell with rigid plate's length equal to L₃=20 mm.

FIG. 14A is a vertical cross-section of a unit cell.

FIG. 14B is a vertical cross-section of four unit cell placed in two layers.

FIG. 14C is a graph of an option for a shape of a force-displacement loop that can be obtained with two layers of unit cells of the architected material shown in FIG. 14B compared to one layer of a unit cell in FIG. 14A.

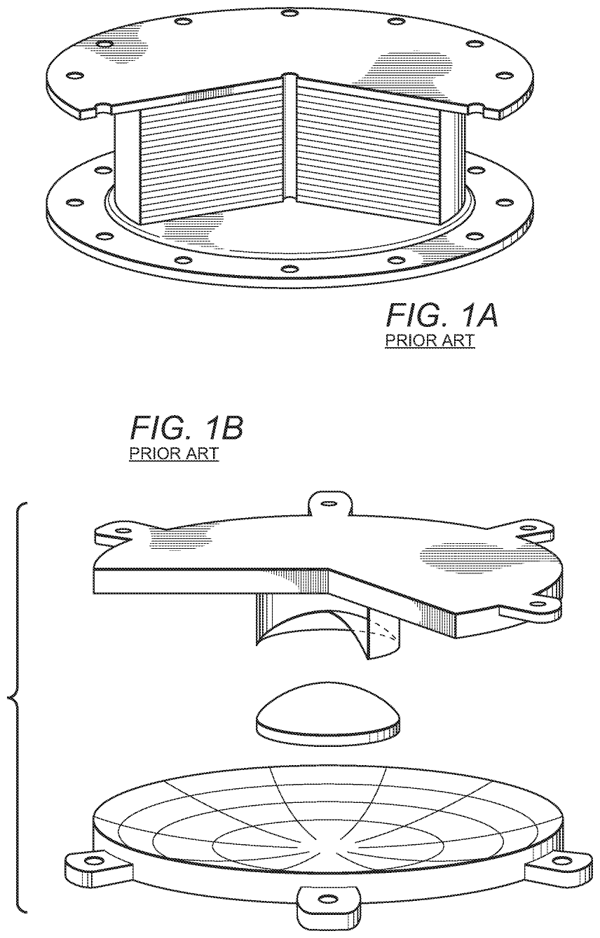

### DETAILED DESCRIPTION

The inventive subject matter provides apparatus, systems, and methods in which a novel class of materials can be used for the seismic protection of structures, bridges, and machines.

While the inventive subject matter is susceptible of various modification and alternative embodiments, certain illustrated embodiments thereof are shown in the drawings and will be described below in detail. It should be understood, however, that there is no intention to limit the invention to the specific form disclosed, but on the contrary, the invention is to cover all modifications, alternative embodiments, and equivalents falling within the scope of the claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified, thus fulfilling the written description of all Markush groups used in the appended claims.

One inventive subject matter includes seismic protection materials. Seismic isolators can be made of one or more of the seismic protection materials described herein. The seismic protection material(s) can be differently shaped and sized in order to meet the requirements of each type of application. Compact-shape, light-weight isolators overcoming traditional isolators' limitations can be obtained through optimization of the unit cell properties.

Preferred seismic protection materials include architected, three-dimensional, periodic, cellular materials obtained as periodic reproduction of a unit cell in all spatial directions. Especially preferred embodiments of the periodic cellular material can be obtained through assemblage of unit cells. In comparison with existing technologies, the use of architected periodic cellular materials greatly widens the range of seismic isolators' properties used to match seismic design requirements. A main aspect of the invention is the development and design of a novel class of materials that can be used for the seismic protection of structures, bridges, and machines to overcome the existing isolators' drawbacks.

It is contemplated that the periodic cellular materials can be designed at different scales (e.g., micro-mini architected material, etc.) in order to obtain unprecedented tailored combinations of mechanical properties, such as high stiffness and strength in the vertical direction combined with high flexibility and dissipative capability in the lateral directions.

In addition, contemplated periodic cellular materials can advantageously be tailored to specific seismic isolation applications. One great benefit of having seismic isolators made of periodic cellular materials is that their seismic performances can be optimized at the material level trough the sizing/geometry optimization of the unit cell. In comparison with existing technologies relying on specific materials' properties, the use of architected periodic cellular materials greatly increases the flexibility in the choice of the isolators' properties in order to satisfy design requirements. Thus, devices made of architected cellular materials will have unprecedented combinations of mechanical properties, with a tremendous impact in the field of seismic isolation. Seismic isolators made of the new materials can be differently shaped and sized in order to meet the requirements of each type of application (e.g., bridge structures, high rise/low rise buildings, new or existing buildings, etc.). Compact shapes and light weight isolators will be obtained through optimization of the unit cell properties in order to overcome traditional isolators' limitations in terms of size and weight. The material optimization will be particularly beneficial to overcome the drawbacks of excessive height of rubber bearings, with consequent augmented risk of instability, and the large size of friction pendulum isolators for near fault's applications.

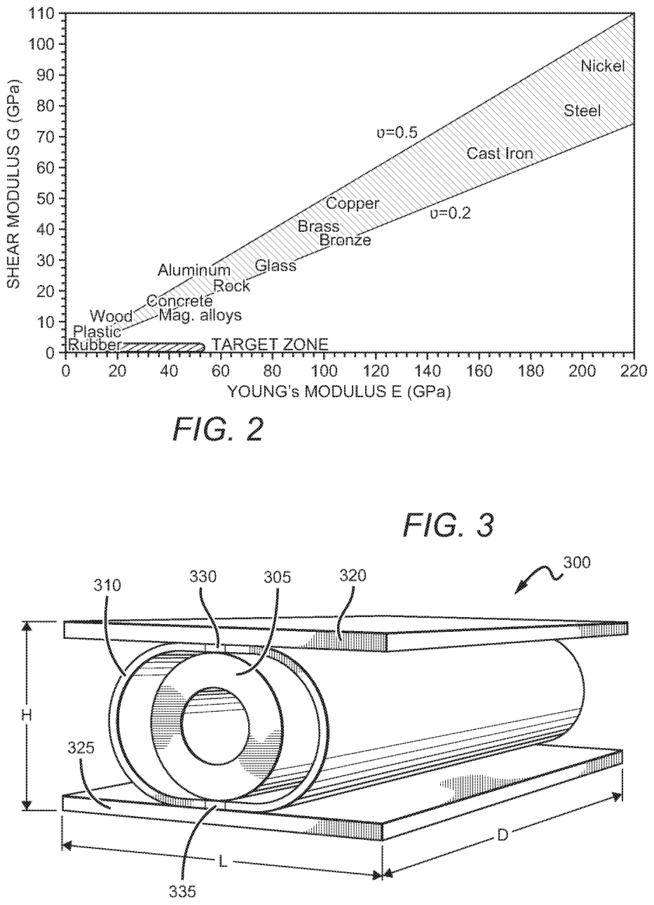

As shown in FIG. 2, the architected material(s) expand(s) the current bounds of traditional material properties spaces and achieves combinations of properties currently unavailable in any existing material. The architected material(s) is/are designed to have a high Young's modulus (E) in the vertical direction, in a range spanning from the modulus of common wood and that of concrete materials, in order to carry the weight of the structure; at the same time have low shear modulus, in the range of common elastomeric materials, in order to accommodate high lateral displacements induced by seismic loads. The targeted stiffness region is depicted in FIG. 2, in comparison with other existing materials.

Specific values of the ratio of Young's modulus to shear modulus and specific dissipative capabilities of the disclosed periodic cellular materials are obtained by modifying dimensions and geometry of the unit cell, rather than with chemical treatments of the constituent materials. Although all design is performed at the unit cell level, when the unit cell is periodically replicated in layers to generate the entire device, the macroscopic properties of the device are the same as those of the unit cell.

FIG. 3 shows one embodiment of a unit cell 300. In this embodiment, a unit cell 300 includes an internal core 305, a left cylindrical shell 310, a right cylindrical shell 315, an upper rigid plate 320 and a bottom rigid plate 325. The internal core 310 and the rigid plates 320, 325 provide support for the weight of the structure, while the cylindrical shells 310, 315 provide lateral stiffness, energy dissipation, and large displacement capability for induced lateral seismic excitations. The geometry size (e.g., height, width, depth, etc) of each unit cell may vary in each embodiment.

In a preferred embodiment, the upper plate 315 and the bottom plate 320 are disposed separately by a non-zero distance depending on the size and dimension of the internal core 305 and/or the cylindrical shells 310. For example, the distance between the upper plate 315 and the bottom plate 320 can vary between 0.1 meter and 0.5 meter, preferably between 0.5 meter and 1 meter, more preferably between 1 meter and 3 meter, etc.).

It is preferred that at least one of the cylindrical shells 310, 315 has at least partially curved perimeter that extends between the upper rigid plate 320 and the bottom rigid plate 325. The curved perimeter can vary depending on the distance, location, or angle between the upper rigid plate 320 and the bottom rigid plate 325.

In some embodiments, the left cylindrical shell 310 and the right cylindrical shell 315 are fastened together directly (e.g., glued, magnetically attached, mechanically fastened by screws, rivets, pins, or sheet metal nuts, welded, etc.) such that the two cylindrical shells 310, 315 are disposed about each other and form a continuous surface of one shell. In other embodiments, the left cylindrical shell 310 and the right cylindrical shell 315 are fastened together at one or more middle blocks 330, 335.

In a preferred embodiment, two cylindrical shells 310, 315, when fastened together, can form a shell in a tubular shape. However, it is contemplated that the shell can be in any suitable shapes (e.g., rectangular shape, etc.).

The internal core 305 is disposed between the upper rigid plate 320 and the bottom rigid plate 325, and also between the left cylindrical shell 310 and the right cylindrical shell 315 (and/or within a space formed by the left cylindrical shell 310 and the right cylindrical shell 315). In a preferred embodiment, the internal core 305 has a cylindrical shape. In another preferred embodiment, the internal core 305 has a spherical shape. However, it is contemplated that the internal core 305 can be in any suitable shapes (e.g., rectangular shape, etc.).

It is contemplated that any suitable material(s) (e.g., rubber, steel, metal, solid plastic material, solid polymer material, PTFE, wood, solid ceramic material, solid composite material, fiberglass, etc.) can be used as constitutive material(s) of the unit cell, and can be chosen based on each specific application. In a preferred embodiment, the unit cell is made of one material. The use of one constitutive material can solve a common drawback of traditional isolators that relies on complex interactions of two or more materials (e.g. rubber and steel in the rubber bearing, steel and PTFE in the friction pendulum bearing). However, it is also contemplated that different part of the unit cell can be made of different materials.

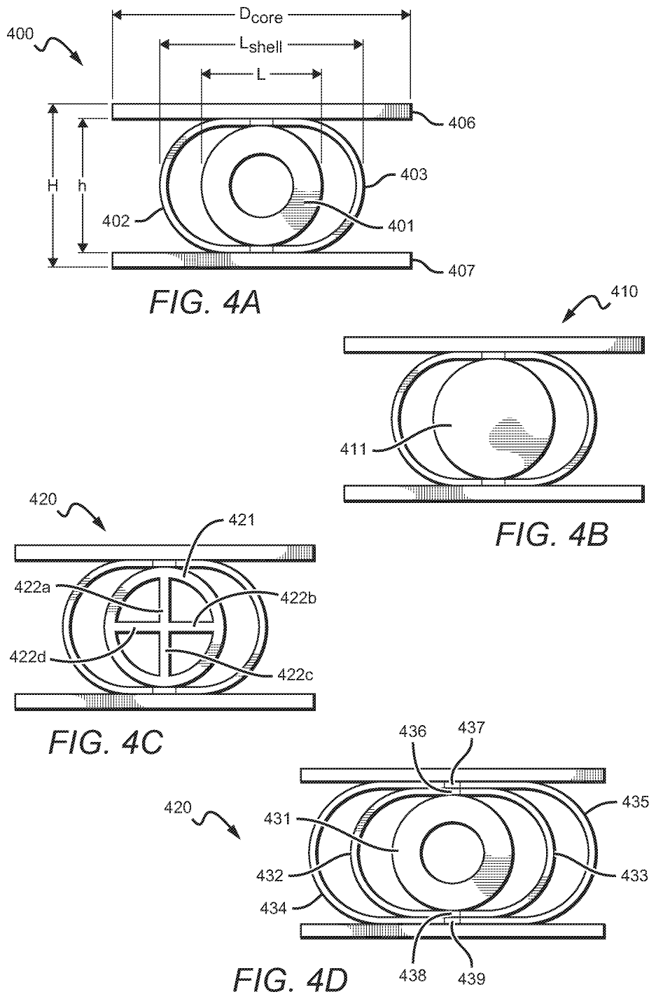

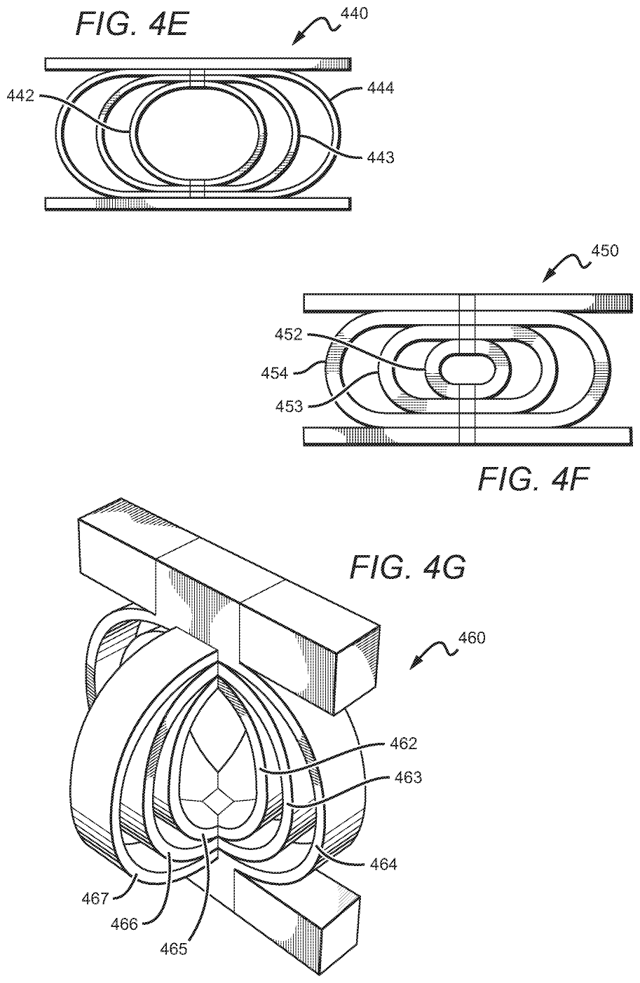

While FIG. 3 shows one exemplary embodiment of a unit cell, a unit cell can be in various shapes and includes additional parts and/or elements depending on the stiffness or strength required for the unit cell. FIGS. 4A-F show various embodiments of a unit cell. It is contemplated that some embodiments may include differently-shaped internal cores. It is also contemplated that other embodiments may include different numbers or shapes of cylindrical shells.

For example, FIG. 4A shows a front view of one embodiment of the unit cell of FIG. 3. In this embodiment, the unit cell 400 includes an internal core 401, wrapped in a shell, which is subdivided in three parts: the left cylindrical shell 402 and the right cylindrical shell 403 and middle blocks 404, 405. In this embodiment, the internal core 401 has a cylinder shape such that it has a hollow core inside. Typically the top and bottom of the each cylindrical shell 402, 403 are connected to an upper plate 406 and a bottom plate 407 through the shell's middle blocks 404, 405, respectively. The thickness (H−h)/2 of the upper and lower plates should be designed to ensure their essentially rigid response upon deformation. The length (L) of the rigid plates corresponds to the horizontal distance between the cells in the assembly.

FIG. 4B shows a unit cell 410 having different configuration of internal core 411 from the unit cell 400 of FIG. 4A. The unit cell 410 has a sphere-shaped internal core 411. In some embodiments, the sphere-shaped internal core 411 has a hollow space inside the sphere. However, it is also contemplated that the inside of the sphere-shaped internal core 411 is at least 90%, preferably at least 95%, more preferably at least 99% filled up.

It is desirable that the internal core 401, 411 is freely rotatable. The freely rotatable internal core provides to the cellular material high vertical stiffness (Young's Modulus E) but low horizontal stiffness (Shear Modulus G), in agreement with the requirement of the target zone in FIG. 2. The cylindrical shells 402, 403 may partially contribute to the vertical stiffness but it mainly provides the restoring force associated with the horizontal stiffness. Also, the cylindrical shell provides energy dissipation trough shearing strain under large horizontal displacement.

FIG. 4C shows another unit cell 420 having different configuration of internal core 421 from the unit cell 400 of FIG. 4A and the unit cell 410 of FIG. 4B. The unit cell 420 has a wheel-section shaped internal core 421. While FIG. 4C depicts a wheel-section shaped internal core 421 with four spokes 422a, 422b, 422c, 422d, it is contemplated that the number of spokes can vary (e.g., 2 spokes, 5 spokes, 6 spokes, etc.).

In some embodiments increasing the number of cylindrical shells may increase the dissipative capacity of the cellular periodic material without increasing the horizontal stiffness. FIG. 4D shows a unit cell 430 having multiple concentric layers of cylindrical shells 432, 433, 434, 435. In this embodiment, the internal core 431 is surrounded by the first cylindrical shells comprising the first left cylindrical shell 432 and the right cylindrical shell 433. The first shell is then further surrounded by the second shell comprising the second left cylindrical shell 434 and the right cylindrical shell 435. In some embodiments, the first shell and the second shell are located in the same plane. However, it is also contemplated that at least a part of the first shell and at least a part of the second shell are placed in the different plane (either parallel or non-parallel). Preferably, two layers of concentric shells are fastened together at either or both upper midblocks 436, 437 and bottom midblocks 438, 439 (e.g., glued, magnetically attached, mechanically fastened by screws, rivets, pins, or sheet metal nuts, welded, etc.). In this embodiment it is further preferred that the internal core 431 is also fastened together with the first cylindrical shell.

Based on the design of the cell, it is contemplated that concentric shells could have the same curvature or different curvatures. For example, FIG. 4E shows a unit cell 440 having multiple layers of cylindrical shells 442, 443, 444. In this unit cell, the radius of curvature of each cylindrical shells 442, 443, 444 are significantly constant. For other example, FIG. 4F shows another unit cell 450 having multiple layers of cylindrical shells 452, 453, 454. In this unit cell, each cylindrical shell 452, 453, 454 has various radius of curvature from another.

In some embodiments, a unit cell may include multiple concentric shells having different curvatures and different orientations. For example, FIG. 4G shows a unit cell 460 having multiple layers of cylindrical shells 462, 463, 464, 465, 466, 467. In this unit cell, the orientation of three layers of cylindrical shells 462, 463, 464 are from other three layers of cylindrical shells 465, 466, 467. For example, the three layers of cylindrical shells 462, 463, 464 and other three layers of cylindrical shells 465, 466, 467 can be perpendicular with each other. However, it is also contemplated that the angle between the three layers of cylindrical shells 462, 463, 464 and other three layers of cylindrical shells 465, 466, 467 can be less than 90 degree, or between 90 degree and 180 degree. In addition, the radius of curvature of each cylindrical shells 462, 463, 464 or of each cylindrical shell 465, 466, 467 can be significantly different from each other.

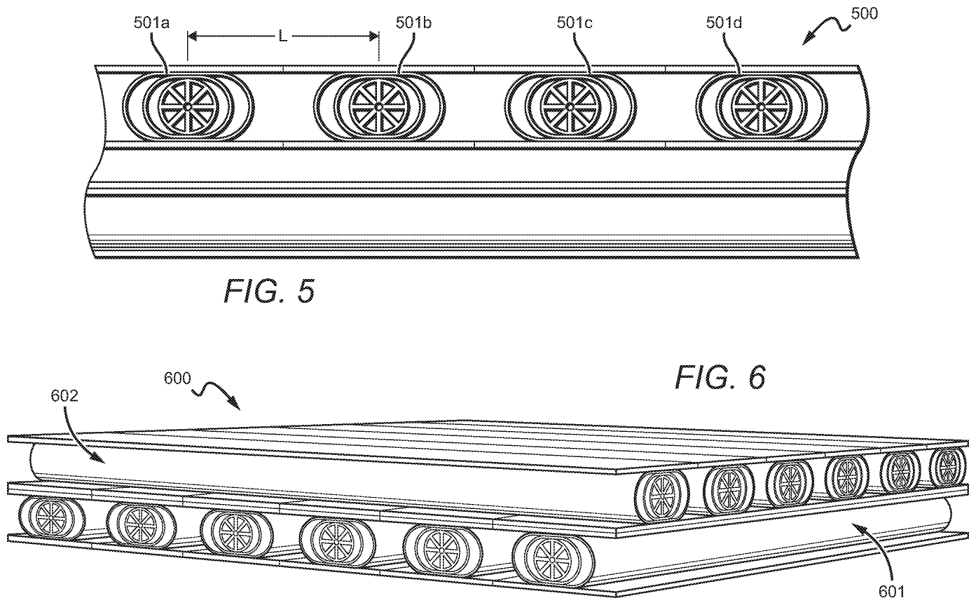

A particular embodiment of this invention is a cellular periodic material obtained by the periodic reproduction in different directions of one or more unit cells. In some embodiments the unit cells can be aggregated in layers. FIG. 5 is a schematic diagram showing an upper layer of unit cells 500 oriented in a first direction, and a bottom layer of unit cells 500 oriented in an orthogonal direction. In this embodiment, it is preferred that multiple unit cells, 501a, 501b, 501c, 501d, are linearly placed in a single plane. In some embodiments, the multiple units are placed in a constant distance (e.g., every 20 cm, every 50 cm, every 1 m, etc.). However, it is contemplated that the multiple units may be placed in various distances with each other.

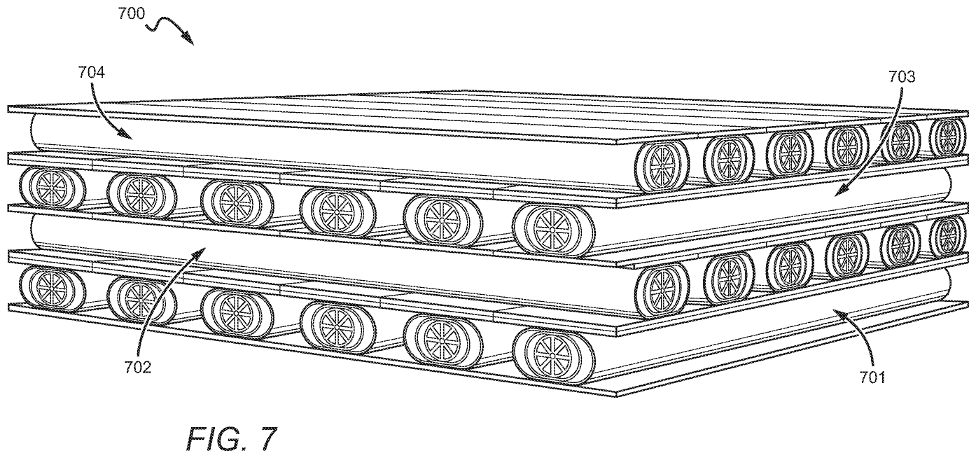

Several layers of unit cells may be combined or stacked together to form a single seismic protection structure (or macroscopic seismic protection object). For example, FIG. 6 and FIG. 7 show multiple layers (two layers in FIGS. 6 and 4 layers in FIG. 7) of unit cells stacked together to form a complex structure 600. In FIG. 6, bottom layer 601 is placed in x direction and upper layer 602 is placed in y direction. Preferably, x direction and y direction are angled at least at 30 degree, preferably at least 45 degree, more preferably at about 90 degree. The upper layer and the bottom layer may be fastened (e.g., glued, magnetically attached, mechanically fastened by screws, rivets, pins, or sheet metal nuts, welded, etc.) together so that the direction of each layer does not move relatively during the seismic event. As used herein, the direction refers a direction of longitudinal section of the single layer.

In FIG. 7, four layers of unit cells are stacked together to form a complex structure 700. In this embodiment, the first layer 701 is placed in x direction and the second layer 702 is placed in y direction. In some embodiments, the third layer 703 is placed in x direction and the fourth layer 704 is placed in y direction such that the first layer and the third layer are parallel with each other and the second and the fourth layers are parallel with each other.

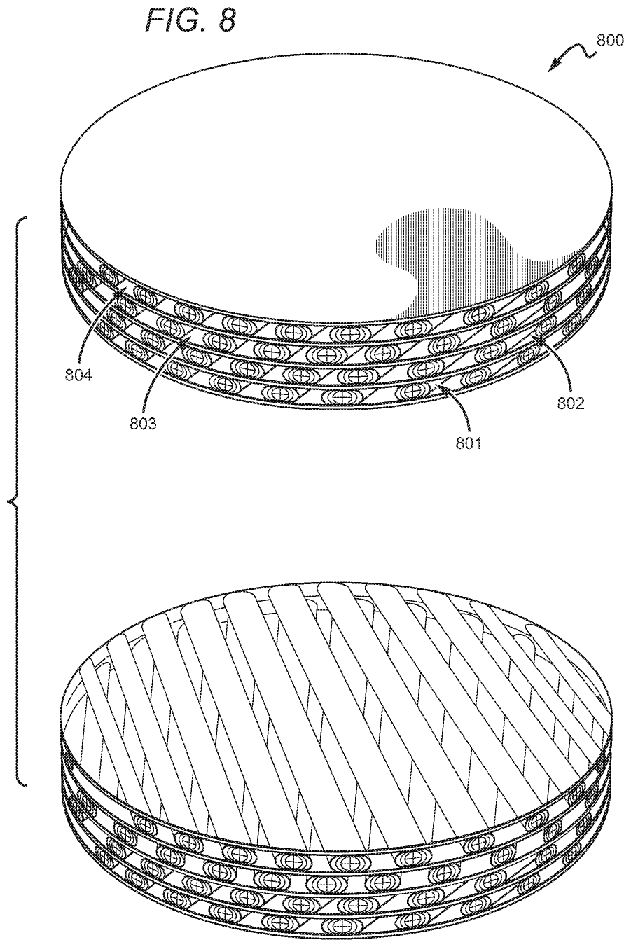

In other embodiments, multiple layers of unit cells can be arranged in several directions. For example, FIG. 8 shows an exemplary arrangement 800 of unit cell layers in several directions. In this embodiment, each of four layers 801, 802, 803, 804, are placed in different directions from each other such that none of layers are parallel with each other.

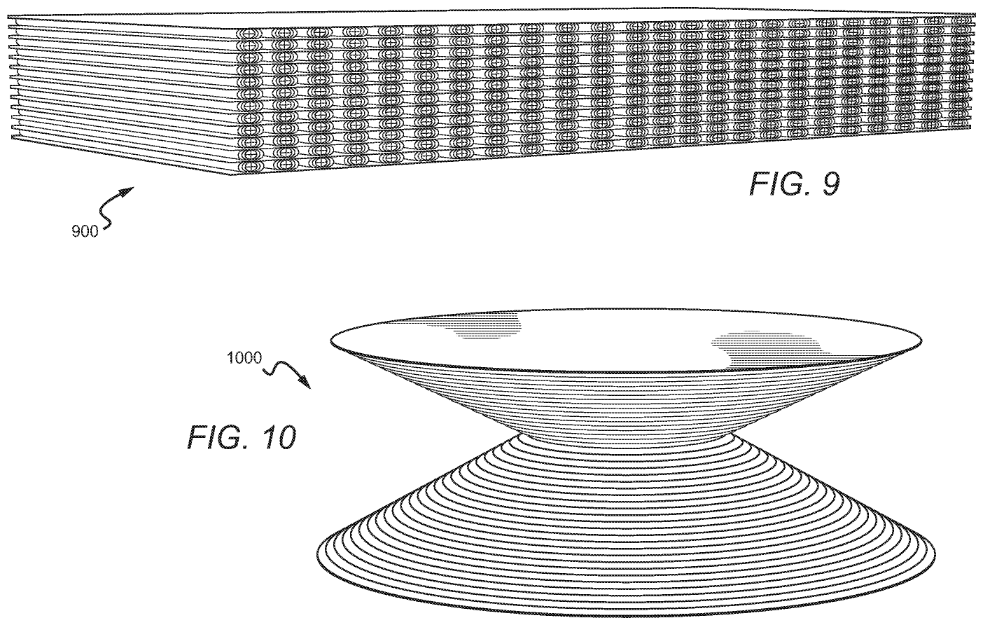

A seismic protection structure (or macroscopic seismic protection object) can be formed in various shapes. For example, as shown in FIG. 8, the seismic protection structure can be in a compact shape with four layers of unit cells placed in different directions. In some embodiments, as shown in FIG. 9, multiple compact shape seismic protection structures can be grouped together to form an n-layer seismic protection structure 900.

The macroscopic object with a compact shape (e.g. as shown in FIG. 8) can be designed in different shapes to be suitable for seismic protection of a variety of structures. For example, as shown in FIG. 10, the n-layer semis seismic protection structure 1000 can be formed in a double cone shape. This shape is particularly useful in a bridge application as it may allow rotation of the deck. Connections to the structure and foundation are not shown as the isolation bearing can be connected using standard methods.

The use of the invented architected material for seismic isolators provides a more reliable alternative to state-of-art isolators made of combinations of different materials. The seismic performances of existing isolators depend on the interaction between a variety of polymers and metallic materials at a macroscopic level. The performance of such isolators is inevitably affected by wear and creep phenomena in the polymers and by complex thermo-dynamic interactions between polymers and metallic assemblies that may unpredictably affect their seismic behavior. The new conceptual design is based on the design of an architected cellular material (with topological features possibly at the micro scale) with tailored mechanical properties, obtained through optimization of the geometry of unit cells rather than on the choice and combination of different materials at the macro-scale.

The proposed cellular material allows unprecedented combinations of mechanical properties, outside the range of traditional materials. These combinations of mechanical properties result in an augmented vibration control performance with respect to state-of-art isolators made of traditional materials. Also, the use of structural material with tailored properties allows a greater variability of solutions in terms of shape, size, and weight of the seismic bearing with respect to existing isolators. Since the mechanical properties of the periodic cellular material are scale independent, the seismic bearing made of this material can be made smaller, more compact, or lighter than existing bearings. As a consequence the seismic bearings made with the claimed material reduce the installation, transportation cost respect to existing seismic bearings. In general the use of isolators made with the claimed material represents a more cost effective seismic isolation solution than the traditional approach.

Lastly, use of the newly architected material reduces costs of prototype and production testing. While traditional isolators require large scale testing to assess their seismic behavior, the new conceptual isolators rely on small scale tests performed on the unit cell, which is representative of the behavior of the macroscopic object. This property of the proposed invention reduces significantly the cost related to the prototyping and production tests that affects state-of-art isolators.

### Examples

Numerical simulations are performed to assess the performance of the newly architected material. Because in the proposed cellular periodic material the mechanical properties (e.g., Young Modulus and Shear Modulus) of the unit cells' layers replicate on a large scale the properties of the unit cell, a numerical simulation of the unit cell was performed.

A finite element model of a particular embodiment of the single cell (embodiment FIG. 4a) is presented under a vertical pressure of 20 MPa and for lateral deflections resulting in shearing forces of 20%-30% of the structure weight. This load scenario may represent the behavior for Maximum Credible Earthquakes.

A parametric analysis based on the variation of some geometrical parameters of the unit cell is performed in order to show how the mechanical property of the architected material can be optimized by changing the geometry of unit cell.

A set of values for shells thickness (S1=0.1 mm, S2=0.2 mm, S3=0.4 mm), a set of values for the length of the rigid plate (L1=5 mm, L2=10 mm, L3=20 mm), and two different sections for the internal core (full and hollow sections) are considered. The total height of the cell H is assumed equal to 4 mm.

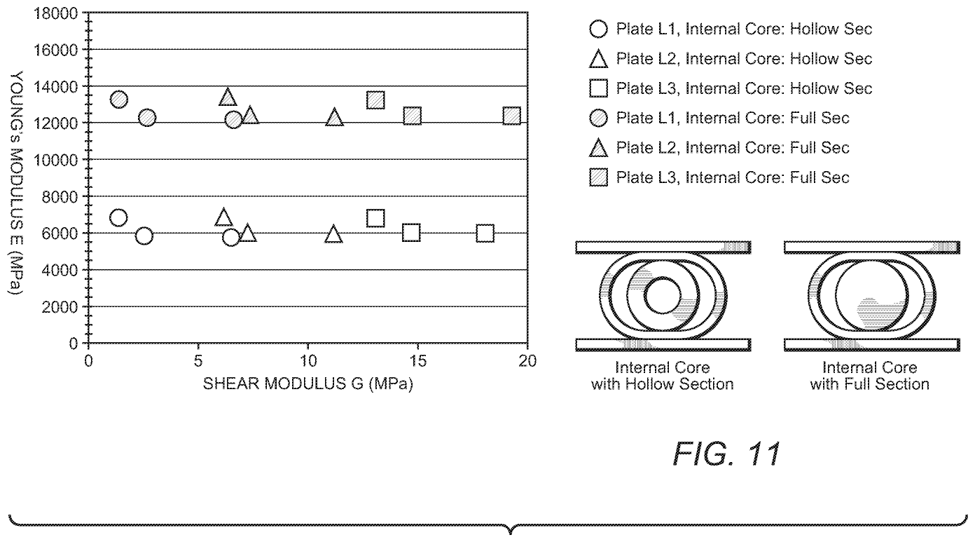

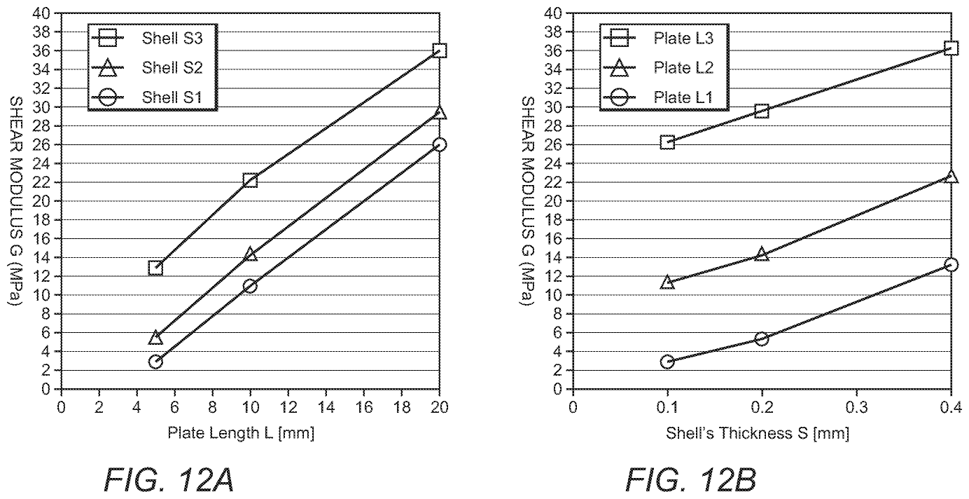

As shown in FIG. 11, the set of Young Modulus and Shear Modulus of the newly architected materials meet the requirements of the target area of FIG. 2. The equivalent Young modulus can be optimized through the section design of the internal core while the equivalent shear modulus can be targeted by optimizing the length of the plate (L) or thickness of the shells (S) as shown in FIGS. 12A-B. Particularly, it is desired that a shear strain deformation capacity ranges between 0.2 and 2, a Shear modulus to Young's modulus ratio G/E ranges between 0.01 and 0.1, and a damping ratio ranges between 0.05 and 0.40.

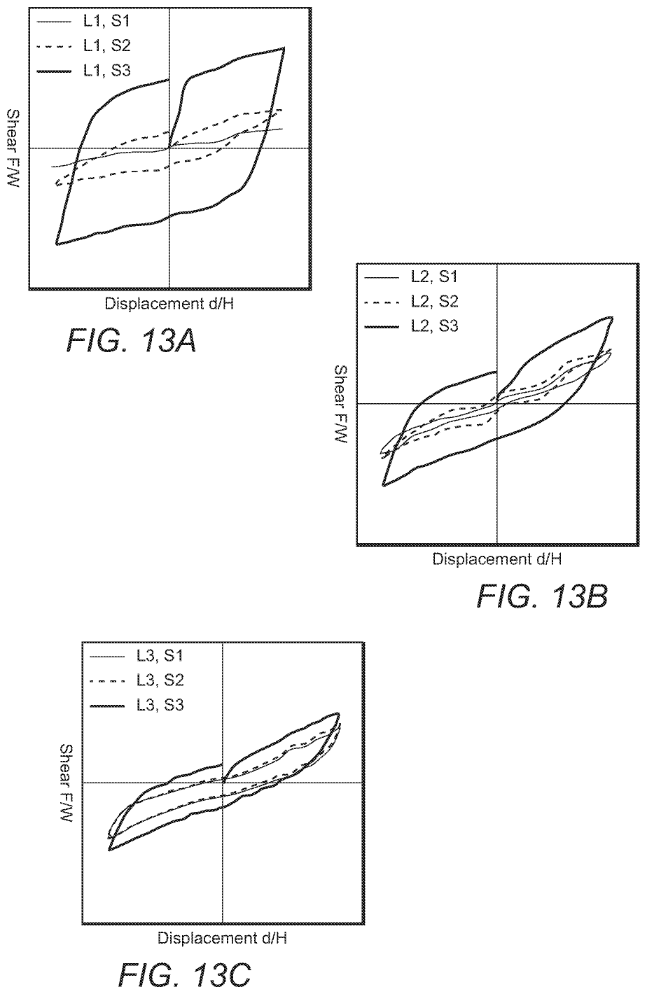

The normalized force-displacement curve of a seismic isolator made with the architected material with the unit cell as defined before are reported in FIGS. 13(a), 13(b), and 13(c). FIGS. 13(a), 13(b), and 13(c) show different shapes of the force-displacement loops that could be obtained simply by changing the geometry of the single cell. Particularly, the deformation capability and dissipative capacity for shearing deflections can be easily modified by changing the geometry of the single cell. In general the force-displacement curves show an initial elastic stiffness, followed by a plastic hardening behavior.

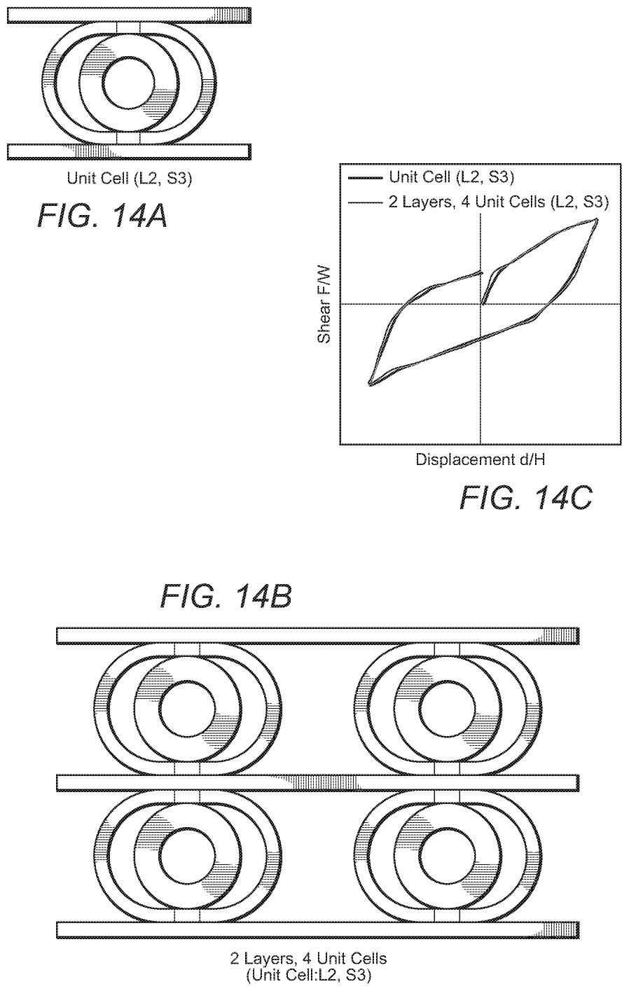

The properties of the seismic material are not affected by the size of the macroscopic object (e.g., assemblage of unit cells). FIG. 14C compares the normalized force-displacement behavior of one unit cell (shown in FIG. 14A) with the global force displacement behavior of an assembly obtained by replicating the same unit cell in vertical and horizontal direction (in two layers as shown in FIG. 14B). Since the normalized force/displacement relationships in the two models are the same, the claimed architected material can be assumed scale-independent.

The proposed example refers to a particular embodiment of the single cell. However size, geometry and load pattern of the single cell may vary in different embodiments of this invention.

It is further contemplated that a seismic isolator as discussed herein could be coupled with a viscous damper or other additional energy dissipation device.

It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. An apparatus for seismic isolation, comprising:
a seismic protection structure having a multitude of unit cells, wherein each unit cell comprises:
(a) at least first and second plates disposed separately by a non-zero distance,
(b) at least a first shell having a cross-section that is elliptical, wherein the first shell is disposed between the first and second plates such that the first and second plates sandwich the first shell, and
(c) a first core disposed within the first shell having a cross-section that is circular, wherein the first shell touches the first core at two opposing points as such to allow for the first core to roll within the first shell.

2. The apparatus of claim 1 wherein the perimeter has a curvature that varies between the first and second plates.

3. The apparatus of claim 1 wherein the seismic protection structure comprises at least first and second layers, each layer comprising a plurality of unit cells such that the second plates of the plurality of unit cells in the first layer are the first plates of the plurality of unit cells of the second layer.

4. The apparatus of claim 1 wherein the seismic protection structure comprises a first and second arrays of the unit cell oriented in different directions, respectively.

5. The apparatus of claim 1 wherein first and second instances of the unit cell each comprise a material selected from the group consisting of solid metallic materials, solid polymeric materials, solid ceramic materials, and solid composite materials.

6. The apparatus of claim 1 wherein first and second instances of the unit cells comprise different first and second materials selected from the group consisting of solid metallic materials, solid polymeric materials, solid ceramic materials, and solid composite materials.

7. The apparatus of claim 1 comprising the seismic protection structure having the plurality of unit cells with a shear strain deformation capacity between 0.2 and 2, a Shear modulus to Young's modulus ratio G/E between 0.01 and 0.1, and a damping ratio between 0.05 and 0.40.

8. The apparatus of claim 1 comprising the seismic protection structure having the plurality of unit cells with a shear strain deformation capacity between 0.2 and 2, a Shear modulus to Young's modulus ratio G<10 GPA and E=10 to 60 GPA between 0.01 and 0.1, and a damping ratio between 0.05 and 0.40.

9. A method of providing seismic protection for a structure, comprising supporting the structure at least in part with a seismic isolation apparatus as described in claim 1.

10. The method of claim 9 further comprising including in the structure an additional energy dissipation device.

11. The apparatus of claim 3 wherein the seismic protection structure has an hourglass shape.

12. The apparatus of claim 1 wherein the seismic protection structure has a height to width ratio between 0.05 and 0.5, inclusive.

13. An apparatus for seismic isolation comprising: a seismic protection structure comprising:
(a) a first plate and a second plate separated by a non-zero distance; and
(b) a shell having a cross-section that is elliptical, wherein the shell is disposed between the first and second plates such that the first and second plates sandwich the first shell;
(c) a first core disposed within the first shell having a cross-section that is circular, wherein the first shell touches the first core at two opposing points as such to allow for the first core to roll within the first shell; and
wherein the seismic protection structure has a void to full volume ratio between 0.02 and 0.5, inclusive.

14. The apparatus of claim 1 wherein the first shell comprises a left shell and a right shell.

15. The apparatus of claim 14, wherein the first shell further comprises a first middle block and a second middle block.

16. The apparatus of claim 15, wherein the first plate is connected to the first middle block and the second plate is connected to the second middle block.

17. The apparatus of claim 1, wherein the non-zero distance is at least the height of the first shell.
